(19) United States
(12) Patent Application Publication
(10) Pub. No.: US 2003/0079348 A1
(43) Pub. Date: May 1, 2003

(54) Razor assembly with replaceable cartridge

(76) Inventor: Thomas A. Follo, Milford, CT (US)

Correspondence Address: PFIZER INC., PATENT DEPARTMENT, MS8260-1611, EASTERN POINT ROAD, GROTON, CT, 06340, US

(21) Appl. No.: 10/285,152

(22) Filed: Oct. 31, 2002

Related U.S. Application Data
(60) Provisional application No. 60/343,723, filed on Nov. 1, 2001.

(51) Int. Cl. B26B 21/16; B26B 21/52

(52) U.S. Cl. 30/50; 30/532; 30/527

(57) ABSTRACT

A razor assembly is provided that includes a handle, a replaceable cartridge, one or more clip members, and a substantially rigid pivot member. The replaceable cartridge includes a frame and one or more razor blades. The pivot member is attached to the handle. The one or more clip members are attached to the replaceable cartridge. When loading the replaceable cartridge onto the handle, the one or more clip members deflect to receive the substantially rigid pivot member and thereby pivotally mount the replaceable cartridge on the pivot member. The replaceable cartridge is selectively detachable from the pivot member to enable replacement of the cartridge by the user. The term “substantially rigid” is used to describe the fact that the pivot member will not appreciably move (e.g., deflect, translate, etc.) relative to the replaceable cartridge during the loading or unloading of the replaceable cartridge.

### BACKGROUND OF THE INVENTION

1. Technical Field.

This invention relates to shaving devices in general, and to shaving devices that utilize a replaceable cartridge in particular.

2. Background Information.

Modern safety razors include a plurality of blades disposed within a cartridge that is pivotally or rigidly mounted on a handle. Some safety razors have a disposable cartridge for use with a reusable handle, while others have a handle and cartridge that are combined into a unitary disposable. Although a variety of razor cartridge configurations exist, most include a frame made of a rigid plastic and a plurality of blades mounted in the frame. The frame includes a seat portion and a cap portion, and the blades are disposed between the cap and the seat. The cartridge further includes a guard disposed forward of the blades and a cap is disposed aft of the blades. The guard and the cap orient the position of the person's skin relative to the blades to optimize the shaving action of the blade. The terms “forward” and “aft”, as used herein, define relative position between two or more things. A feature “forward” of the razor blades, for example, is positioned so that the surface to be shaved encounters the feature before it encounters the razor blades, if the razor assembly is being stroked in its intended cutting direction (e.g., the guard is forward of the razor blades). A feature “aft” of the razor blades is positioned so that the surface to be shaved encounters the feature after it encounters the razor blades, if the razor assembly is being stroked in its intended cutting direction (e.g., the cap is disposed aft of the razor blades).

The comfort and performance provided by a particular razor are critical to the commercial success of the razor. Improvements that benefit razor comfort, performance, and ease of use, however significant or subtle, can have a decided impact on the commercial success of a razor. The attachment mechanism between a replaceable cartridge and the handle of the razor, for example, is a feature that can significantly affect the razor's ease of use. Presently available razor cartridge attachment mechanisms typically employ a plurality of small features (e.g., tabs, posts, etc.) to attach the cartridge to the handle. In many instances, the small attachment features increase the difficulty of attaching the handle and cartridge to one another. This is particularly true when it is not clear how the small features attach the cartridge to the handle. The small features also often make the razor components difficult to manufacture, susceptible to mechanical problems (e.g., misalignment, failure, etc.), and expensive to manufacture. Because most presently available razor attachment mechanisms are complex, they are typically disposed in the reusable handle. If the cartridge attachment mechanism fails in the handle, the user is left stranded. Additional cartridges will not solve the problem. The user must change razors, assuming an alternative razor is available.

What is needed, therefore, is a razor assembly that has a durable handle and replaceable cartridge, one that facilitates loading and unloading of the replaceable cartridge, and one that is readily manufacturable.

### DISCLOSURE OF THE INVENTION

It is, therefore, an object of the present invention to provide a razor assembly that has a durable handle and replaceable cartridge, one that facilitates loading and unloading of the replaceable cartridge, and one that is readily manufacturable.

According to the present invention, a razor assembly is provided that includes a handle, a replaceable cartridge, one or more clip members, and a substantially rigid pivot member. The replaceable cartridge includes a frame and one or more razor blades. The pivot member is attached to the handle. The one or more clip members are attached to the replaceable cartridge. When loading the replaceable cartridge onto the handle, the one or more clip members deflect to receive the substantially rigid pivot member and thereby pivotally mount the replaceable cartridge on the pivot member. The replaceable cartridge is selectively detachable from the pivot member to enable replacement of the cartridge by the user. The term “substantially rigid” is used to describe the fact that the pivot member will not appreciably move (e.g., deflect, translate, etc.) relative to the replaceable cartridge during the loading or unloading of the replaceable cartridge.

The present invention razor assembly provides several advantages. First, the substantially rigid pivot member attached to the handle and the one or more clip members that deflect to receive the pivot member eliminate the need to provide any attachment mechanism within the handle; e.g., a movable, translatable, or deflectable mechanism within the reusable handle. As a result, the durability of the handle is greatly increased. The manufacturing process for the handle is also greatly improved because of fewer parts, decreased assembly steps, decreased cost, etc. Equally important is the perception of quality provided to the consumer by the present razor assembly. Favorable consumer perception is critical to the commercial success of a razor assembly.

Another advantage provided by the present invention razor assembly is easy loading and unloading of the razor cartridge. The substantially rigid pivot member enables the user to easily determine how the cartridge is loaded and unloaded from the handle. A person who has used existing replaceable razor cartridges will recognize that it is very often less than clear how the cartridge and handle attach to one another, particularly when attachment is accomplished via a plurality of small features. The substantially rigid pivot member attached to the handle and the one or more clip members attached to the replaceable cartridge, in contrast, make it quite clear how the cartridge is attached to the handle.

The size (e.g., diameter and effective length) and rigidity of the pivot member also provide a connection between the handle and the replaceable cartridge that favorably supports the replaceable cartridge along its length thereby eliminating the undesirable deflection that can be a characteristic of the small attachment features used in many presently available products.

These and other objects, features, and advantages of the present invention will become apparent in light of the detailed description of the present invention.

### BRIEF DESCRIPTION OF THE DRAWINGS

FIG. 1 is an isometric view of a present invention razor assembly.

FIG. 2 is an exploded view of a present invention razor assembly, wherein the handle and pivot member are detached from the replaceable cartridge and a portion of the handle is broken away to show the pivot member.

FIG. 3 is a planar view of a portion of the handle attached to the replaceable cartridge, showing the under side of the replaceable cartridge.

FIG. 4 is a sectional view of the handle portion and replaceable cartridge shown in FIG. 3, sectioned along the line 4-4.

FIG. 5 is a diagrammatic view of an alternative embodiment of the present invention wherein the pivot member is attached to the replaceable cartridge.

FIG. 6 is a diagrammatic view of an alternative embodiment of the present invention wherein the pivot member is attached to the replaceable cartridge.

FIG. 7 is a diagrammatic view of an alternative embodiment of the pivot member attached to the handle.

FIG. 8 is a side sectional view taken along line 8-8 of FIG. 4.

### DETAILED DESCRIPTION OF THE INVENTION

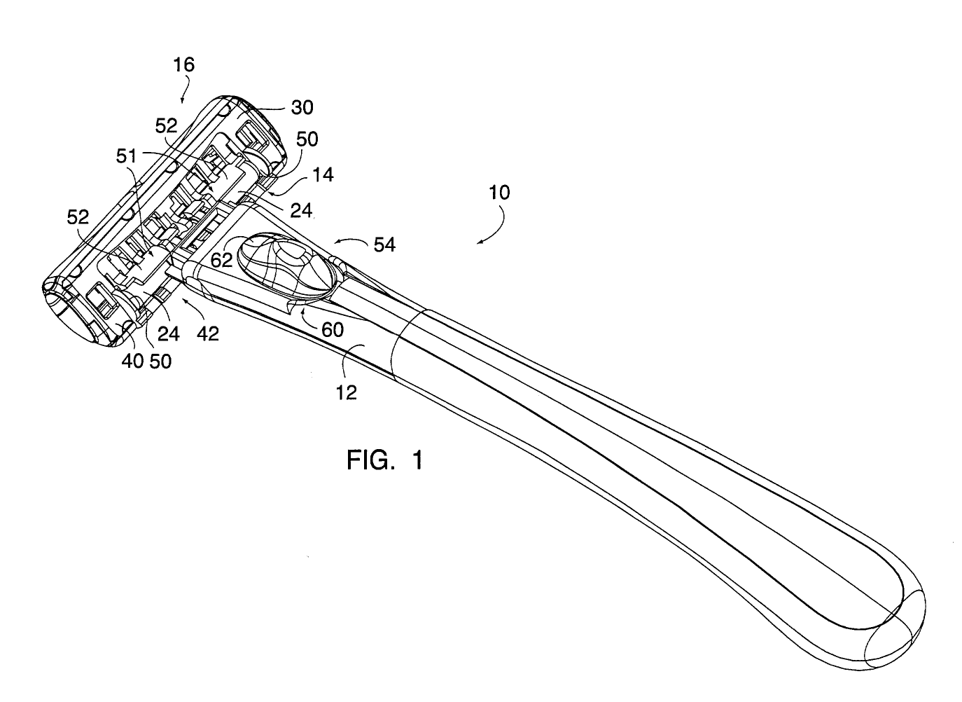

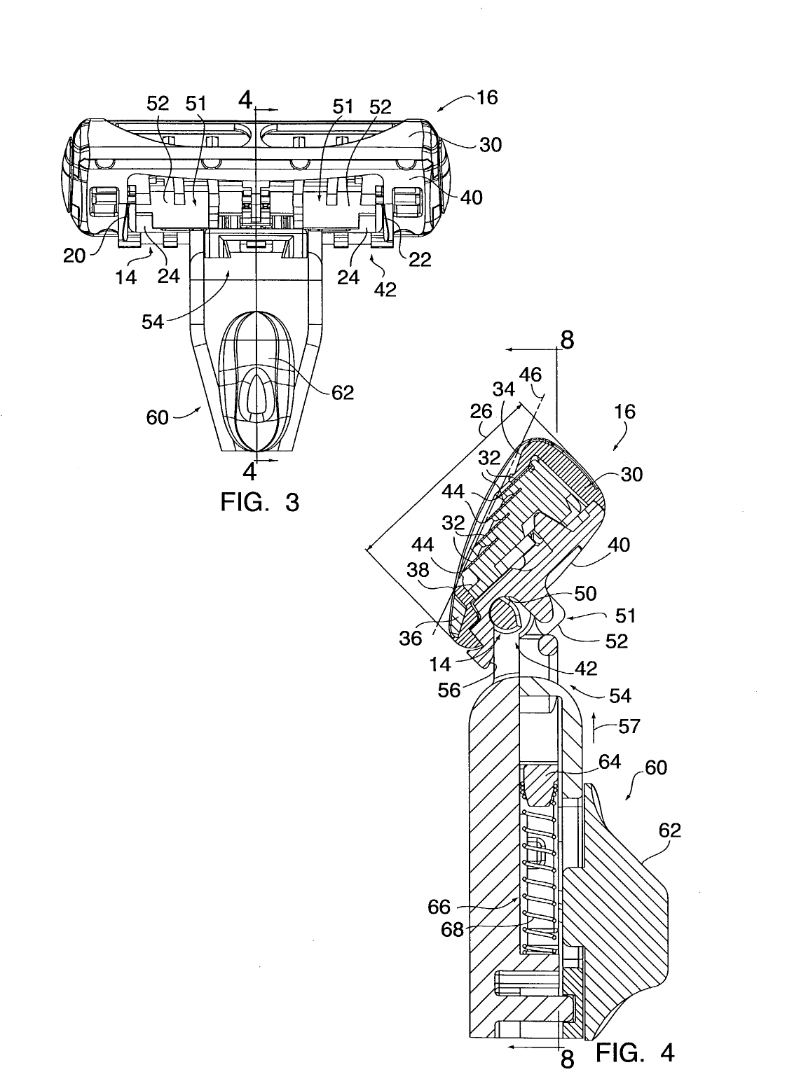

Referring to FIGS. 1-4, a razor assembly 10 includes a handle 12, a pivot member 14, and a replaceable cartridge 16. The replaceable cartridge 16 is pivotal relative to the pivot member 14.

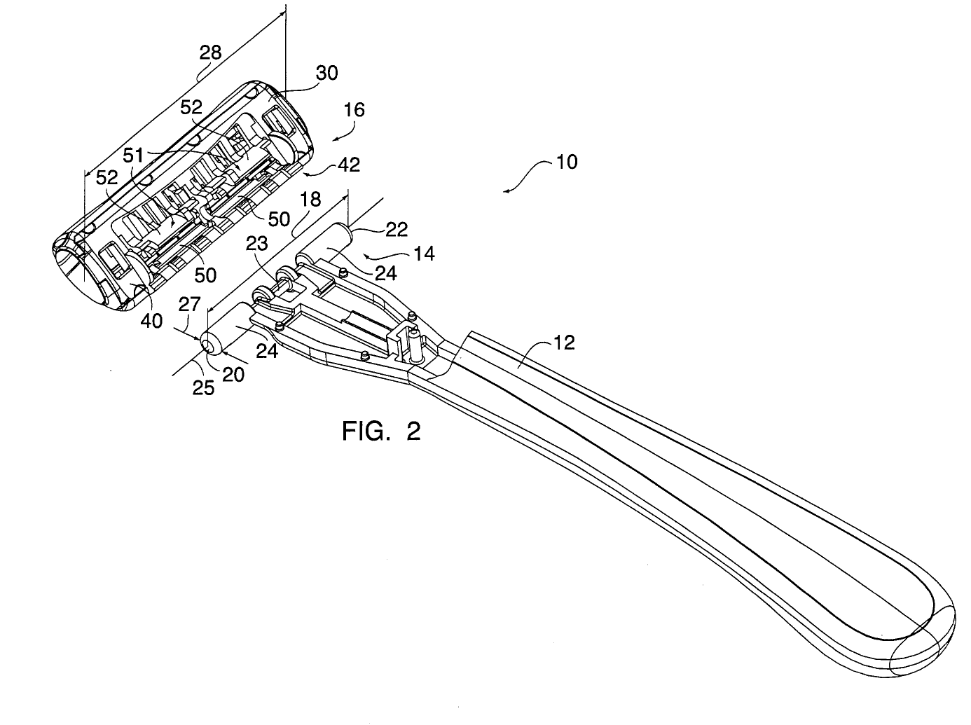

Referring to FIGS. 2 and 7, the pivot member 14 is a substantially rigid member that is fixedly or moveably attached to the handle 12. The term “substantially rigid” is used to describe the fact that the pivot member 14 will not appreciably deflect during the loading or unloading of the replaceable cartridge 16. Accordingly, attachment between the replaceable cartridge 16 and the handle 12 (as will be described below) is performed without any appreciable deflection, movement, or translation of the pivot member 14 relative to the replaceable cartridge 16. The pivot member 14 has an effective length 18 (see FIG. 2) that extends between a pair of end surfaces 20,22. The pivot member 14 can comprise a single journal 24 with a substantially constant cross-section extending the full length of the pivot member 14 or a plurality of journals 24 disposed along a common lengthwise extending rotational axis 25. The plurality of journals 24 may be independent of one another (FIG. 7), or they may be connected to one another by interconnect portions 23 that extend along the same common axis 25. The journal or journal portions 24 have an arcuate cross-section, preferably cylindrical having a diameter 27, that facilitates the pivotal attachment between pivot member 14 and the replacement cartridge 16, as will be discussed below. The effective length 18 of the pivot member 14 is preferably equal to or greater than one-half of the length 28 of the replacement cartridge 16. In a more preferred embodiment, the effective length 18 of the pivot member 14 is equal to or greater than three-quarters of the length 28 of the replacement cartridge 16.

Referring to FIGS. 2-4, the replaceable cartridge 16 has a width 26 (see FIG. 4) and a length 28 and includes a frame 30, one or more razor blades 32, a cap 34, a guard 36, a razor side 38, an under side 40, and a handle mounting mechanism 42. The guard 36, cap 34, and one or more razor blades 32 are attached to the frame 30. Each of the one or more razor blades 32 includes a cutting edge 44, and the cutting edges 44 of the one or more razor blades 32 each extend lengthwise and are positioned contiguous with a shave plane 46. The shave plane 46 (sometimes referred to as the “contact plane”) represents the theoretical position of the surface being shaved, and is defined by a widthwise extending line that is tangential to the outer surfaces of the cap 34 and guard 36, and a lengthwise extending line that extends along the length of the cartridge 16. A variety of guards 36 can be used with the present invention. Guards 36 are well known in the art and will therefore not be discussed further here other than to say the present invention is not limited to being used with any particular type of guard 36. The guard 36 is attached to the frame 30 forward of the cutting edges 44 of the razor blades 32. The cap 34 is disposed aft of the cutting edges 44 of the razor blades 32.

The handle mounting mechanism 42 includes one or more pivot sockets 50 for receiving the pivot member 14 and one or more clip members 51 for holding the pivot member 14 within the pivot sockets 50. The one or more pivot sockets 50 are disposed within, or outside of, the frame 30 on the under side 40 of the frame 30. The pivot sockets 50 preferably have a cross-section that is shaped to match the cross-section of the pivot member 14; e.g., a pivot socket 50 with an arcuate cross-section for receiving a cylindrical pivot member 14. The clip members 51 are shaped so that a user pushing a pivot member 14 against the clip members 51 with sufficient force cause the clip members 51 to move, and permit passage of the pivot member 14 into the one or more pivot sockets 50. In the preferred embodiment, the “movement” of the clip members 51 is accomplished by elastic flexure. The movement of the clip members 51 is not, however, limited to elastic flexure. Once the pivot member 14 is received within the pivot sockets 50, the one or more clip members 51 recover and retain the pivot member 14 within the pivot sockets 50. In the embodiment shown in FIGS. 1-4, the clip members 51 are in the form of flexible tabs 52 that are aligned with the journal or journals 24 of the pivot member 14. The flexible tabs 52 may be independent of the pivot sockets 50, or they may form a portion of the pivot sockets 50. The clip members 51 are not limited to flexible tabs 52 that are aligned with pivot member 14 journals 24, however. Clip members 51 can act on any portion of the pivot member 14 along the axis 25 of the pivot member 14.

The ratio of the width 26 of the replaceable cartridge 16 to the pivot member diameter 27 is preferably between 1:10 and 1:2 (e.g., 1 width=10 diameters, 1 width =2 diameters). In a more preferred embodiment, the ratio of the width 26 of the replaceable cartridge 16 to the pivot member diameter 27 is between 1:5 and 1:3 (e.g., 1 width=5 diameters, 1 width=2 diameters). The large size of the diameter 27 relative to the width 26 facilitates the provision of a pivot member 14 with desirable rigidity; e.g., a wider variety of materials can be used. In addition, the larger size of the pivot member 14 also increases the durability of the reusable handle and makes it easy for a user to recognize how the cartridge is loaded and unloaded.

In some embodiments, the razor assembly 10 further includes an ejector 54 for selectively detaching the replaceable cartridge 16 from the pivot member 14. In the exemplary embodiment shown in FIGS. 1, 3, and 4, the ejector 54 includes a cam 56 attached to the frame 30 of the replaceable cartridge 16. The cam 56 is disposed forward of the one or more pivot sockets 50. A force applied to one or more of the flexible tabs 52 (or other surface aft of the pivot sockets 50) in the direction shown by arrow 57 causes the replaceable cartridge 16 to rotate around the pivot member 14 until the cam 56 contacts the handle 12. Further travel of the flexible tabs 52 in the same direction causes the replacement cartridge 16 to pivot about the cam 56, and thereby cause the pivot member 14 to disengage from the one or more pivot sockets 50. Once the pivot member 14 is disengaged from the one or more pivot sockets 50, the replaceable cartridge 16 is detached from the handle 12. The ejector 54 preferably includes an actuator 60 attached to the handle 12 proximate the pivot member. In this embodiment, a thumb pad 62 is attached to a plunger 64 (see FIG. 4), and the plunger 64 is slidably mounted within the handle 12. The replaceable cartridge 16 may be detached from handle 12 by pushing the thumb pad 62 and plunger 64 into contact with at least one of the flexible tabs 52, and subsequently rotating the replaceable cartridge 16 around the pivot member 14 an amount sufficient for the cam 56 to contact the handle 12. Further similar movement will cause the pivot member 14 to disengage with the one or more pivot sockets 50, in a manner similar to that described-above. FIG. 4 shows the actuator 60 located on the aft side of the handle 12. The actuator 60 can be located on the forward side of the handle 12 alternatively, and the cartridge 16 removed by rotating it in the opposite manner to that described above.

In some embodiments, the razor assembly 10 further includes a cartridge biasing mechanism 66. The cartridge biasing mechanism 66 biases the replaceable cartridge 16 into a normal position and resists rotation of the cartridge in one direction as will be described below. In FIG. 4, the biasing mechanism 66 is disposed aft of the handle 12 and combined with the ejector 54. A spring 68 acts on one end of the plunger 64 and biases the plunger 64 into contact with the flexible tab 52. The replaceable cartridge 16 is, in turn, biased into the normal position. Rotation of the replaceable cartridge 16 in a clockwise direction (from the perspective of FIG. 4) is resisted by the spring 68.

In the operation of the razor assembly 10, a replaceable cartridge 16 is selectively attached (i.e., “loaded”) to the handle 12 by pushing the pivot member 14 attached to the handle 12, against the one or more clip members 51 located on the under side 40 of the replacement cartridge 16 with sufficient force to cause the clip members 51 to elastically flex and permit passage of the pivot member 14 into the one or more pivot sockets 50. Once the pivot member 14 is received within the pivot socket(s) 50, the one or more clip members 51 elastically recover and retain the pivot member 14 within the pivot socket(s) 50. The pivot member journal or journals 24 received within the one or more pivot sockets 50 function as a bearing assembly for the pivotal motion of the replacement cartridge 16 relative to the handle 12. The replaceable cartridge 16 can be selectively detached (i.e., “unloaded”) from the handle 12 by pushing under side 40 of the replaceable cartridge 16 either directly, or indirectly via the ejector plunger 64, an amount sufficient for the pivot member 14 to rotate out of engagement with the one or more pivot sockets 50.

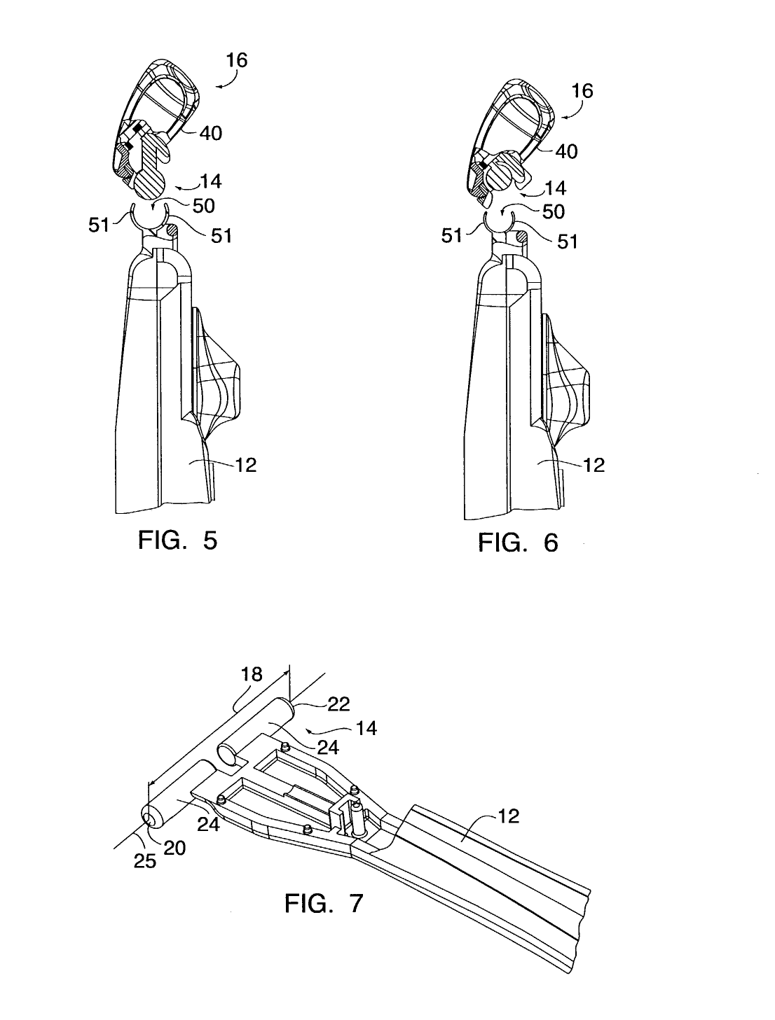

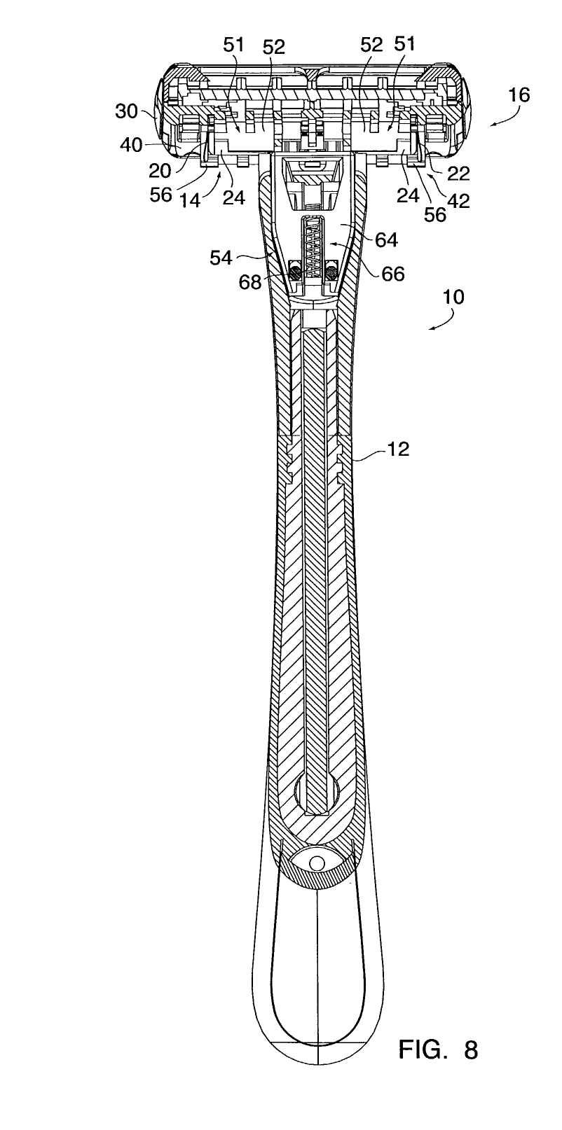

Although this invention has been shown and described with respect to the detailed embodiments thereof, it will be understood by those skilled in the art that various changes in form and detail thereof may be made without departing from the spirit and scope of the invention. For example, the present invention has been described above as having a rigid pivot member 14 attached to the handle 12, and a replaceable cartridge 16 having one or more pivot sockets 50 with clip members 51 for retaining the pivot member 14. In an alternative embodiment, as can be seen in FIGS. 5 and 6, the replaceable cartridge 16 can include a rigid pivot member 14 disposed along the under side 40 of the cartridge 16 and the handle 12 can include one or more pivot sockets 50 and clip members 51 for receiving and retaining the pivot member 14. FIG. 5 shows a pivot member 14 attached externally to the under side 40 of the replaceable cartridge 16 and FIG. 6 shows a pivot member 14 disposed substantially within the under side 40 of the replaceable cartridge 16. In this alternative embodiment, the pivot member 14 is similar to that described above (e.g., substantially rigid, etc.) except that it is attached to the replaceable cartridge.

What is claimed is:

1. A razor assembly, comprising:
a handle;
a replaceable cartridge that includes a frame, one or more razor blades, one or more clip members, a width, and a length;
a pivot member attached to the handle, wherein the pivot member is substantially rigid; and
wherein the one or more clip members attached to the replaceable cartridge move to receive and retain the pivot member and thereby pivotally mount the replaceable cartridge on the pivot member; and
wherein the replaceable cartridge is selectively detachable from the pivot member.

2. The razor assembly of claim 1, wherein the clip members attached to the replaceable cartridge elastically deflect to receive and retain the pivot member.

3. The razor assembly of claim 2, wherein the clip members are flexible tabs.

4. The razor assembly of claim 3, wherein the flexible tabs are aligned with journal portions of the pivot member.

5. The razor assembly of claim 1, wherein the pivot member comprises at least two journal portions disposed along a common axis.

6. The razor assembly of claim 5, wherein each journal portion of the pivot member is independent of each other journal portion of the pivot member.

7. The razor assembly of claim 6, wherein the pivot member has an effective length that is equal to or greater than one half of the length of the replaceable cartridge.

8. The razor assembly of claim 7, wherein the pivot member has an effective length that is equal to or greater than three-quarters of the length of the replaceable cartridge.

9. The razor assembly of claim 5, wherein each journal portion of the pivot member is connected to each other journal portion of the pivot member by an interconnect portion.

10. The razor assembly of claim 9, wherein the pivot member has an effective length that is equal to or greater than one half of the length of the replaceable cartridge.

11. The razor assembly of claim 10, wherein the pivot member has an effective length that is equal to or greater than three-quarters of the length of the replaceable cartridge.

12. The razor assembly of claim 1, wherein the pivot member has a diameter, and wherein a ratio of the width of the replaceable cartridge to the diameter of the pivot member is between about 1:10 to about 1:2.

13. The razor assembly of claim 12, wherein the ratio of the width of the replaceable cartridge to the diameter of the pivot member is between about 1:5 to about 1:3.

14. The razor assembly of claim 1, further comprising an ejector for selectively detaching the replaceable cartridge from the pivot member.

15. The razor assembly of claim 14, wherein the ejector comprises a cam attached to the frame of the replaceable cartridge, forward of the handle.

16. The razor assembly of claim 15, wherein the ejector further comprises an actuator attached to the handle, the actuator includes a plunger slidably mounted on the handle, wherein the plunger can be slidably actuated to disengage the pivot member from the replaceable cartridge.

17. The razor assembly of claim 16, wherein the actuator further comprises a spring that biases the plunger toward the replaceable cartridge.

18. The razor assembly of claim 1, wherein the replaceable cartridge further includes one or more pivot sockets for receiving the pivot member.

19. The razor assembly of claim 18, wherein the one or more pivot sockets are disposed within an under side of the replaceable cartridge.

20. The razor assembly of claim 19, wherein the one or more clip members attached to the replaceable cartridge retain the pivot member within the one or more pivot sockets.

21. The razor assembly of claim 20, wherein the one or more pivot sockets have a cross-sectional shape and the pivot member includes one or more journals having a cross-sectional shape, and wherein the cross-sectional shapes of the one or more pivot sockets and the one or more journals match each other.

22. The razor assembly of claim 21, wherein the one or more clip members form a portion of the pivot sockets.

23. The razor assembly of claim 22, wherein the clip members elastically flex to receive and retain the pivot member.

24. The razor assembly of claim 20, wherein the one or more clip members form a portion of the pivot sockets.

25. The razor assembly of claim 24, wherein the clip members elastically flex to receive and retain the pivot member.

26. The razor assembly of claim 20, wherein the clip members act on one or more interconnect portions of the pivot member that extend along a rotational axis of the pivot member.

27. The razor assembly of claim 1, further comprising a cartridge biasing mechanism, wherein the cartridge biasing mechanism biases the replaceable cartridge to rotate around the pivot member in a predetermined direction.

28. A replaceable razor cartridge, comprising:
a frame having a width, a length, a razor side, and an under side;
one or more razor blades, each have a cutting edge adjacent the razor side of the frame; and
one or more clip members attached to the frame on the under side of the frame, wherein the one or more clip members move to receive and retain a pivot member attached to a handle and thereby pivotally mount the replaceable cartridge on the handle.

29. The replaceable razor cartridge of claim 28, wherein the clip members attached to the frame move by elastically deflecting to receive and retain the pivot member.

30. The replaceable razor cartridge of claim 29, wherein the clip members are flexible tabs.

31. The replaceable razor cartridge of claim 28, further comprising one or more pivot sockets for receiving the pivot member.

32. The replaceable razor cartridge of claim 31, wherein the one or more pivot sockets are disposed within the under side.

33. The replaceable razor cartridge of claim 32, wherein the one or more clip members retain the pivot member within the one or more pivot sockets.

34. The replaceable razor cartridge of claim 33, wherein the one or more clip members form a portion of the pivot sockets.

35. The replaceable razor cartridge of claim 34, wherein the clip members elastically flex to receive and retain the pivot member.

36. A razor handle for a razor assembly having a replaceable cartridge, wherein the handle comprises:
a grip portion; and
a pivot member attached to an end of the handle opposite the grip portion, wherein the pivot member is substantially rigid and has one or more journal portions.
